(19) United States
(12) Patent Application Publication
(10) Pub. No.: US 2024/0161407 A1
(43) Pub. Date: May 16, 2024

(54) SYSTEM AND METHOD FOR SIMPLIFIED FACIAL CAPTURE WITH HEAD-MOUNTED CAMERAS

(71) Applicant: Digital Domain Virtual Human (US), Inc., Los Angeles, CA (US)

(72) Inventors: Lucio Dorneles MOSER, Vancouver (CA); David Allen MCLEAN, Thousand Oaks, CA (US); José Mário Figueiredo SERRA, Vancouver (CA)

(73) Assignee: Digital Domain Virtual Human (US), Inc., Los Angeles, CA (US)

(21) Appl. No.: 18/421,710

(22) Filed: Jan. 24, 2024

Related U.S. Application Data
(63) Continuation of application No. PCT/CA2022/051157, filed on Jul. 27, 2022.
(60) Provisional application No. 63/228,134, filed on Aug. 1, 2021.

(51) Int. Cl. G06T 17/20; G06T 7/20; G06T 7/30; G06T 7/73; G06T 13/40

(52) U.S. Cl. CPC G06T 17/205; G06T 7/20; G06T 7/30; G06T 7/73; G06T 13/40; G06T 2207/20081; G06T 2207/30201

(57) ABSTRACT

Methods are provided for generating training data in a form of a plurality of frames of facial animation, each of the plurality of frames represented as a three-dimensional (3D) mesh comprising a plurality of vertices. The training data is usable to train an actor-specific actor-to-mesh conversion model which, when trained, receives a performance of the actor captured by a head-mounted camera (HMC) set-up and infers a corresponding actor-specific 3D mesh of the performance of the actor. The methods may involve performing a blendshape optimization to obtain a blendshape-optimized 3D mesh and performing a mesh-deformation refinement on the blendshape-optimized 3D mesh to obtain a mesh-deformation-optimized 3D mesh. The training data may be generated on the basis of the mesh-deformation-optimized 3D mesh.

### REFERENCE TO RELATED APPLICATIONS

This application is a continuation of Patent Cooperation Treaty (PCT) application No. PCT/CA2022/051157 filed 27 Jan. 2022 which in turn claims priority from, and for the purposes of the United States, the benefit under 35 USC 119 in connection with, U.S. patent application No. 63/228,134 filed 1 Aug. 2021. All of the applications referred to in this paragraph are hereby incorporated herein by reference.

### TECHNICAL FIELD

This application is directed to systems and methods for computer animation of faces. More particularly, this application is directed to systems and methods for generating computer representations of actor specific 3D-meshes using image data captured from head-mounted cameras.

### BACKGROUND

There is a desire in various computer-generated (CG) animation applications to generate computer representations of the facial characteristics of specific actors. Typically, these computer representations take the form of 3D meshes of interconnected vertices where the vertices have attributes (e.g. 3D geometry or 3D positions) that change from frame to frame to create animation.

FIG. 1A shows a typical method 10 for imparting the facial characteristics of an actor onto such a computer representation. Method 10 involves capturing an actor's performance, typically with a head-mounted camera (HMC), to obtain a captured actor performance 12. The HMC setup typically uses at least 2 cameras which can be used to capture 3D information stereoscopically, as is known in the art. Typically, when the actor performs for the HMC (top capture actor performance 12), the actor's face is marked with markers placed at strategic locations around the actors face and the markers are tracked as part of captured actor performance 12.

Captured actor performance 12 is then used by a trained AI model (actor-to-mesh conversion model) 14 in block 16 to convert the actor's captured performance 12 into a 3D CG mesh 18 of the actor's performance. When actor-to-mesh conversion model 14 is properly trained, output 3D CG performance mesh 18 closely matches the facial characteristics of the capture actor performance 12 on a frame-by-frame basis. A non-limiting example of an actor-to-mesh conversion model 14 is the so-called “masquerade” model described in Lucio Moser, Darren Hendler, and Doug Roble. 2017. Masquerade: fine—scale details for head-mounted camera motion capture data. In ACM SIGGRAPH 2017 Talks (SIGGRAPH '17). Association for Computing Machinery, New York, NY, USA, Article 18, 1-2. FIG. 1B shows a frame 26 in which the left hand side 28 shows an HMC-captured actor performance 12 and the right hand side 30 shows a rendering of corresponding output 3D CG performance mesh 18 for the same frame using the masquerade actor-to-mesh conversion model 14.

Before using trained actor-to-mesh conversion model 14 in block 16, actor-to-mesh conversion model 14 must be trained (see block 20 of FIG. 1A). Training actor-to-mesh conversion model 14 requires training data 22. This training data 22 typically takes the form of a series of frames (video), where each frame takes the form of an actor specific 3D-mesh (typically having the same mesh topology as the desired output 3D CG performance mesh 18), where the actor is arranging their face over a so-called range of motion (ROM). A ROM may have a number of poses, some of which may be realistic poses (e.g. actor smiling, actor frowning, actor open mouth, actor close mouth, actor neutral expression and/or the like) and some of which may be contrived poses. Method 10 of FIG. 1A shows that training data 22 is obtained in step 24.

FIG. 1C shows a prior art method 40 for obtaining training data 22. Method 40 (FIG. 1C) may be performed in step 24 (FIG. 1A). Method 40 starts in block 42 which involves capturing as much facial detail as possible about the actor in a light stage, for example. A light stage is an environment and supporting structure that typically includes many cameras and lights that capture details of the actor's face, such as the surface face geometry and multiple textures that may be used for creating digital doubles of the actor. While light stage-captured images have excellent detail about the actor, light stage-captured images typically have topologies which are too dense and unstructured and so are not suitable for use in other aspects of method 10. Consequently, a typical next step (not expressly shown) involves processing the light stage-captured data to generate a common neutral model topology 44 that may be used for the next steps of method 40 and method 10 Then, there is a second step (shown as block 46 in FIG. 1C) which involves capturing the actor's performance of a ROM. Typically, this ROM capture step 46 is performed while the actor is seated using something on the order of 6-10 cameras. This ROM capture step 46 takes (as input) neutral mesh topology 44 together with the actors performance of a number of ROM poses to generate an actor-specific ROM of a high resolution mesh 22, which can be used as training data 22 to train the actor-to-mesh conversion model 14 in method 10 of FIG. 1A. In typical cases, the data captured in the seated capture of step 46 has a different topology than that of neutral mesh 44. Consequently, the data captured in the seated capture of step 46 is further processed (not expressly shown) to conform to the topology of neutral mesh 44 before being output as actor-specific ROM of a high resolution mesh 22. The ROM capture step 46 is typically performed using the seated-capture setups and proprietary software of organizations, such as, for example, the Institute for Creative Technologies (ICT) at the University of Southern California (USC), the Di4D of Dimensional Imaging, Ltd. and/or the like.

The procedures of method 40 (FIG. 1C) for generating an actor-specific ROM of a high resolution 3D CG mesh 22, which can be used as training data 22 to train the actor-to-mesh conversion model 14 in method 10 of FIG. 1A are cumbersome, expensive (both in terms of computational resources and time), require sequential processing steps and require the actor to attend to multiple different capture sessions.

There is a general desire for an improved method for generating training data (in the form of an actor-specific ROM of a high resolution 3D CG mesh) that can be used to train an actor-to-mesh conversion model like the model 14 of FIG. 1 and systems capable of performing such a method.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a method for generating training data in a form of a plurality of frames of facial animation, each of the plurality of frames represented as a three-dimensional (3D) mesh comprising a plurality of vertices, the training data usable to train an actor-specific actor-to-mesh conversion model which, when trained, receives a performance of the actor captured by a head-mounted camera (HMC) set-up and infers a corresponding actor-specific 3D mesh of the performance of the actor. The method comprises: receiving, as input, an actor range of motion (ROM) performance captured by a HMC set-up, the HMC-captured ROM performance comprising a number of frames of high resolution image data, each frame captured by a plurality of cameras to provide a corresponding plurality of images for each frame; receiving or generating an approximate actor-specific ROM of a 3D mesh topology comprising a plurality of vertices, the approximate actor-specific ROM comprising a number of frames of the 3D mesh topology, each frame specifying the 3D positions of the plurality of vertices; performing a blendshape decomposition of the approximate actor-specific ROM to yield a blendshape basis or a plurality of blendshapes; performing a blendshape optimization to obtain a blendshape-optimized 3D mesh, the blendshape optimization comprising determining, for each frame of the HMC-captured ROM performance, a vector of blendshape weights and a plurality of transformation parameters which, when applied to the blendshape basis to reconstruct the 3D mesh topology, minimize a blendshape optimization loss function which attributes loss to differences between the reconstructed 3D mesh topology and the frame of the HMC-captured ROM performance; performing a mesh-deformation refinement on the blendshape-optimized 3D mesh to obtain a mesh-deformation-optimized 3D mesh, the mesh-deformation refinement comprising determining, for each frame of the HMC-captured ROM performance, 3D locations of a plurality of handle vertices which, when applied to the blendshape-optimized 3D mesh using a mesh-deformation technique, minimize a mesh-deformation refinement loss function which attributes loss to differences between the deformed 3D mesh topology and the HMC-captured ROM performance; and generating the training data based on the mesh-deformation-optimized 3D mesh.

The blendshape optimization loss function may comprise a likelihood term that attributes: relatively high loss to vectors of blendshape weights which, when applied to the blendshape basis to reconstruct the 3D mesh topology, result in reconstructed 3D meshes that are relatively less feasible based on the approximate actor-specific ROM; and relatively low loss to vectors of blendshape weights which, when applied to the blendshape basis to reconstruct the 3D mesh topology, result in reconstructed 3D meshes that are relatively more feasible based on the approximate actor-specific ROM.

For each vector of blendshape weights, the likelihood term may be based on a negative log-likelihood of locations of a subset of vertices reconstructed using the vector of blendshape weights relative to locations of vertices of the approximate actor-specific ROM.

The blendshape optimization may comprise, for each of a plurality of frames of the HMC-captured ROM performance, starting the blendshape optimization process using a vector of blendshape weights and a plurality of transformation parameters previously optimized for a preceding frame of the HMC-captured ROM performance.

Performing the mesh-deformation refinement may comprise determining, for each frame of the HMC-captured ROM performance, 3D locations of the plurality of handle vertices which, when applied to the blendshape-optimized 3D mesh using the mesh-deformation technique for successive pluralities of N frames of the HMC-captured ROM performance, minimize the mesh-deformation refinement loss function.

The mesh-deformation refinement loss function may attribute loss to differences between the deformed 3D mesh topology and the HMC-captured ROM performance over each successive plurality of N frames.

Determining, for each frame of the HMC-captured ROM performance, 3D locations of the plurality of handle vertices may comprise, for each successive plurality of N frames of the HMC-captured ROM performance, using an estimate of 3D locations of the plurality of handle vertices from a frame of the of the HMC-captured ROM performance that precedes the current plurality of N frames of the HMC-captured ROM performance to determine at least part of the mesh-deformation refinement loss function.

Performing the mesh-deformation refinement may comprise, for each frame of the HMC-captured ROM performance, starting with 3D locations of the plurality of handle vertices from the blendshape-optimized 3D mesh.

The mesh deformation technique may comprise at least one of: a Laplacian mesh deformation, a bi-Laplacian mesh deformation, and a combination of the Laplacian mesh deformation and the bi-Laplacian mesh deformation.

The mesh deformation technique may comprise a linear combination of the Laplacian mesh deformation and the bi-Laplacian mesh deformation. Weights for the linear combination of the Laplacian mesh deformation and the bi-Laplacian mesh deformation may be user-configurable parameters.

Generating the training data based on the mesh-deformation-optimized 3D mesh may comprise performing at least one additional iteration of the steps of: performing the blendshape decomposition; performing the blendshape optimization; performing the mesh-deformation refinement; and generating the training data; using the mesh-deformation-optimized 3D mesh from the preceding iteration of these steps as an input in place of the approximate actor-specific ROM.

Generating the training data based on the mesh-deformation-optimized 3D mesh may comprise: receiving user input; modifying one or more frames of the mesh-deformation-optimized 3D mesh based on the user input to thereby provide an iteration output 3D mesh; and generating the training data based on the iteration output 3D mesh.

The user input may be indicative of a modification to one or more initial frames of the mesh-deformation-optimized 3D mesh and modifying the one or more frames of the mesh-deformation-optimized 3D mesh based on the user input may comprise: propagating the modification from the one or more initial frames to one or more further frames of the mesh-deformation-optimized 3D mesh to provide the iteration output 3D mesh.

Propagating the modification from the one or more initial frames to the one or more further frames may comprise implementing a weighted pose-space deformation (WPSD) process.

Generating the training data based on the iteration output 3D mesh may comprise performing at least one additional iteration of the steps of: performing the blendshape decomposition; performing the blendshape optimization; performing the mesh-deformation refinement; and generating the training data; using the iteration output 3D mesh from the preceding iteration of these steps as an input in place of the approximate actor-specific ROM.

The blendshape optimization loss function may comprise a depth term that, for each frame of the HMC-captured ROM performance, attributes loss to differences between depths determined on a basis of the reconstructed 3D mesh topology and depths determined on a basis of the HMC-captured ROM performance.

The blendshape optimization loss function may comprise an optical flow term that, for each frame of the HMC-captured ROM performance, attributes loss to differences between: optical loss determined on a basis of HMC-captured ROM performance for the current frame and at least one preceding frame; and displacement of the vertices of the reconstructed 3D mesh topology between the current frame and the at least one preceding frame.

Determining, for each frame of the HMC-captured ROM performance, the vector of blendshape weights and the plurality of transformation parameters which, when applied to the blendshape basis to reconstruct the 3D mesh topology, minimize the blendshape optimization loss function may comprise: starting by holding the vector of blendshape weights constant and optimizing the plurality of transformation parameters to minimize the blendshape optimization loss function to determine an interim plurality of transformation parameters; and after determining the interim plurality of transformation parameters, allowing the vector of blendshape weights to vary and optimizing the vector of blendshape weights and the plurality of transformation parameters to minimize the blendshape optimization loss function to determine the optimized vector of blendshape weights and plurality of transformation parameters.

Determining, for each frame of the HMC-captured ROM performance, the vector of blendshape weights and the plurality of transformation parameters which, when applied to the blendshape basis to reconstruct the 3D mesh topology, minimize the blendshape optimization loss function may comprise: starting by holding the vector of blendshape weights constant and optimizing the plurality of transformation parameters to minimize the blendshape optimization loss function to determine an interim plurality of transformation parameters; and after determining the interim plurality of transformation parameters, allowing the vector of blendshape weights to vary and optimizing the vector of blendshape weights and the plurality of transformation parameters to minimize the blendshape optimization loss function to determine an interim vector of blendshape weights and a further interim plurality of transformation parameters; after determining the interim vector of blendshape weights and further interim plurality of transformation parameters, introducing a 2-dimensional (2D) constraint term to the blendshape optimization loss function to obtain a modified blendshape optimization loss function and optimizing the vector of blendshape weights and the plurality of transformation parameters to minimize the modified blendshape optimization loss function to determine the optimized vector of blendshape weights and plurality of transformation parameters.

The 2D constraint term may attribute loss, for each frame of the HMC-captured ROM performance, based on differences between locations of vertices associated with 2D landmarks in the reconstructed 3D mesh topology and locations of 2D landmarks identified in the current frame of the HMC-captured ROM performance.

The mesh-deformation refinement loss function may comprise a depth term that, for each frame of the HMC-captured ROM performance, attributes loss to differences between depths determined on a basis of the 3D locations of the plurality of handle vertices applied to the blendshape-optimized 3D mesh using the mesh-deformation technique and depths determined on a basis of the HMC-captured ROM performance.

The mesh-deformation refinement loss function may comprise an optical flow term that, for each frame of the HMC-captured ROM performance, attributes loss to differences between: optical loss determined on a basis of HMC-captured ROM performance for the current frame and at least one preceding frame; and displacement of the vertices determined on a basis of the 3D locations of the plurality of handle vertices applied to the blendshape-optimized 3D mesh using the mesh-deformation technique for the current frame and the at least one preceding frame.

The mesh-deformation refinement loss function may comprise a displacement term which, for each frame of the HMC-captured ROM performance, comprises a per-vertex parameter which expresses a degree of confidence in the vertex positions of the blendshape-optimized 3D mesh.

Another aspect of the invention provides a method for generating a plurality of frames of facial animation corresponding to a performance of an actor captured by a head-mounted camera (HMC) set-up, each of the plurality of frames of facial animation represented as a three-dimensional (3D) mesh comprising a plurality of vertices, the method comprising: receiving, as input, an actor performance captured by a HMC set-up, the HMC-captured actor performance comprising a number of frames of high resolution image data, each frame captured by a plurality of cameras to provide a corresponding plurality of images for each frame; receiving or generating an approximate actor-specific ROM of a 3D mesh topology comprising a plurality of vertices, the approximate actor-specific ROM comprising a number of frames of the 3D mesh topology, each frame specifying the 3D positions of the plurality of vertices; performing a blendshape decomposition of the approximate actor-specific ROM to yield a blendshape basis or a plurality of blendshapes; performing a blendshape optimization to obtain a blendshape-optimized 3D mesh, the blendshape optimization comprising determining, for each frame of the HMC-captured actor performance, a vector of blendshape weights and a plurality of transformation parameters which, when applied to the blendshape basis to reconstruct the 3D mesh topology, minimize a blendshape optimization loss function which attributes loss to differences between the reconstructed 3D mesh topology and the frame of the HMC-captured actor performance; performing a mesh-deformation refinement on the blendshape-optimized 3D mesh to obtain a mesh-deformation-optimized 3D mesh, the mesh-deformation refinement comprising determining, for each frame of the HMC-captured actor performance, 3D locations of a plurality of handle vertices which, when applied to the blendshape-optimized 3D mesh using a mesh-deformation technique, minimize a mesh-deformation refinement loss function which attributes loss to differences between the deformed 3D mesh topology and the HMC-captured actor performance; and generating the plurality of frames of facial animation based on the mesh-deformation-optimized 3D mesh.

This aspect of the invention may comprise any of the features, combinations of features or sub-combinations of features of any of the preceding aspects 24 wherein HMC-captured actor performance is substituted for HMC-captured ROM performance and wherein plurality of frames of facial animation is substituted for training data.

Another aspect of the invention provides an apparatus comprising a processor configured (e.g. by suitable programming) to perform the method of any of the preceding aspects.

Another aspect of the invention provides a computer program product comprising a non-transitory medium which carries a set of computer-readable instructions which, when executed by a data processor, cause the data processor to execute the method of any one of the preceding aspects.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A shows a typical method for imparting the facial characteristics of an actor onto a CG mesh representation of the actor's face.

FIG. 1B shows a frame in which the left hand side shows an HMC-captured actor performance and the right hand side shows a rendering of corresponding output 3D CG performance mesh for the same frame using a particular actor-to-mesh conversion model.

FIG. 1C shows a prior art method for obtaining 3D CG mesh ROM training data that may be used to train the FIG. 1A actor-to-mesh conversion model.

FIG. 1D is a schematic representation of a system that may be configured (e.g. by suitable programming) to perform the various methods described herein.

FIG. 1E shows a method for generating 3D CG mesh ROM training data that may be used to train the FIG. 1A actor-to-mesh conversion model according to a particular embodiment.

FIG. 2 schematically depicts information that is provided by (or extracted from) HMC-captured actor ROM performance with or without markers (input to the FIG. 1E method) according to a particular embodiment.

FIG. 3 shows a method for generating an actor-specific ROM of a CG 3D high resolution mesh based on an HMC-captured actor ROM performance (with or without markers) and a rough actor-specific ROM according to a particular embodiment.

FIG. 4A schematically depicts the blendshape optimization of the FIG. 3 method according to a particular embodiment.

FIG. 4B depicts a controlled blendshape optimization process of the FIG. 3 method for a particular frame according to an example embodiment.

FIG. 5A schematically depicts the Laplacian refinement of the FIG. 3 method according to a particular embodiment.

FIG. 5B depicts a controlled Laplacian refinement method of the FIG. 3 method according to an example embodiment.

FIGS. 6A and 6B respectively depict renderings of a frame of blendshape-optimized 3D CG mesh output from the FIG. 3 blendshape optimization (once transformed using optimized transform parameters) and a corresponding frame of Laplacian-optimized 3D CG mesh output from the FIG. 3 Laplacian refinement process (once transformed using optimized transform parameters).

FIG. 7 depicts a method for incorporating manual fixes to Laplacian-optimized 3D CG mesh to obtain an iteration output 3D CG mesh according to a particular embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

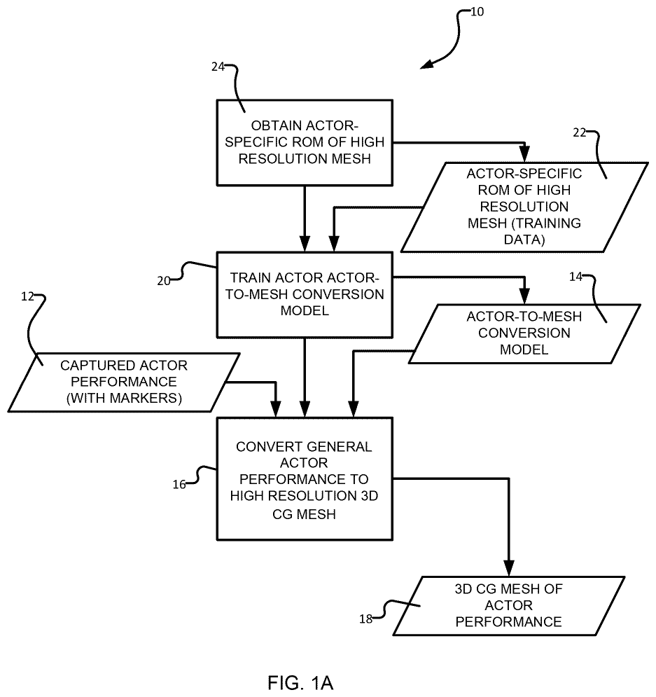

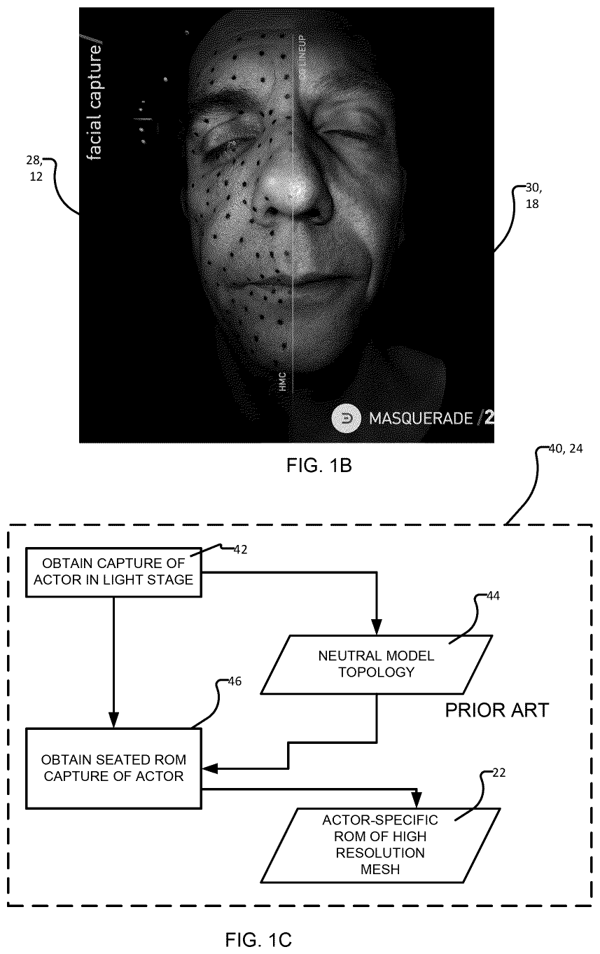

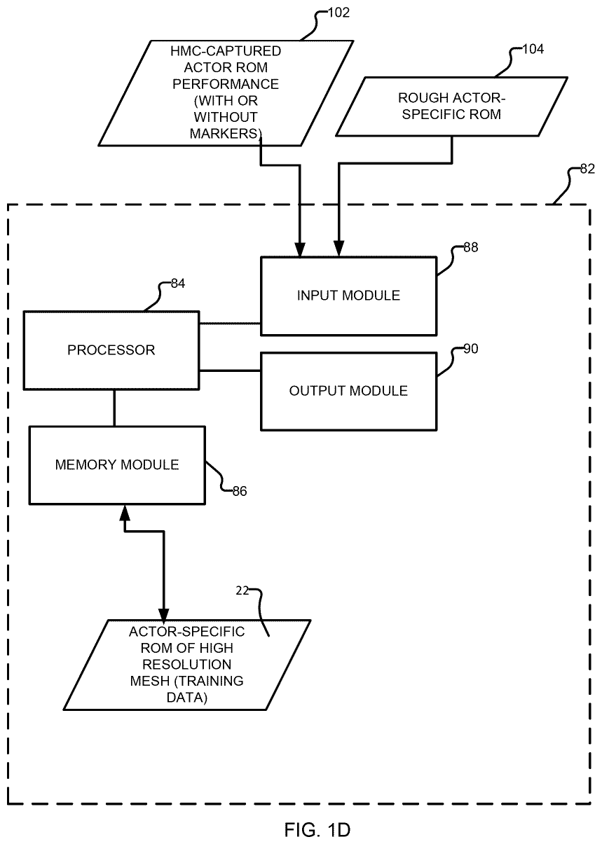

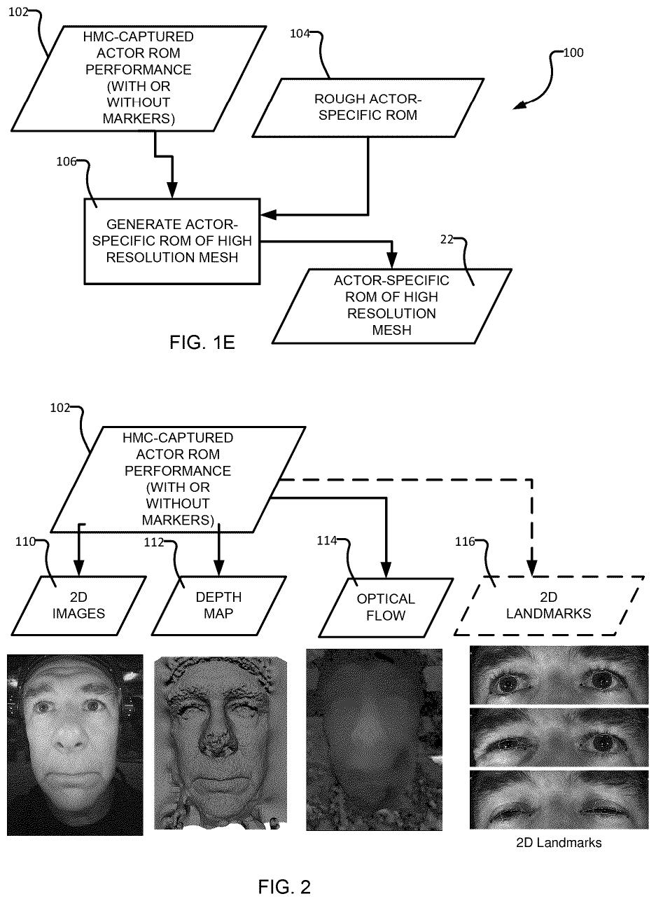

One aspect of the invention provides a method for generating training data (in the form of an actor-specific ROM of a high resolution 3D CG mesh) 22 that can be used to train an actor-to-mesh conversion model like the model 14 of FIG. 1 and systems capable of performing such a method. While training data 22 is described herein as ROM data, training data and/or all of the other ROM data described and/or claimed herein are not limited to ROM data. Any such ROM data could include additional images and/or sequences of frames in addition to ROM data. In some embodiments, such methods use ROM input captures from a head-mounted camera (HMC) set-up. Conveniently, the actor performing for the HMC is already part of using actor-to-mesh model 14. That is, actor-to-mesh model 14 uses the frames of an HMC-captured actor performance 12 as input. Consequently, input may be captured to train actor-to-mesh model 14 and to use actor-to-mesh model 14 to infer the 3D CG mesh of the actor's performance 18 using the same HMC setup.

Some aspects of the invention provide a system 82 (an example embodiment of which is shown schematically in FIG. 1D) for performing one or more of the methods described herein. System 82 may comprise a processor 84, a memory module 86, an input module 88, and an output module 90. Input module 88 may receive input, such as an HMC-captured actor ROM performance 102 and a rough actor-specific ROM 104 (explained in more detail below). In some embodiments, processor 84 may generate rough actor-specific ROM 104 based on other inputs. Memory module 86 may store one or more of the models and/or representations described herein. Processor 84 may generate training data (in the form of an actor-specific ROM of a high resolution 3D CG mesh) 22 using the methods described herein, and may store this training data 22 in memory module 86. Processor 84 may retrieve training data 22 from memory module 86 and use training data 22 to train an actor-to-mesh model, like the actor-to-mesh model 14 of FIG. 1.

FIG. 1E shows a method 100 for generating 3D CG mesh ROM training data 22 that may be used to train the FIG. 1A actor-to-mesh conversion model 14 according to a particular embodiment. Method 100 takes (as input) an HMC-captured actor ROM performance 102 (with or without markers) and a rough actor-specific ROM 104 and, in step 106, generates 3D CG mesh ROM training data 22 that may be used to train the FIG. 1A actor-to-mesh conversion model 14. Each of these aspects of method 100 is described in more detail below.

FIG. 2 schematically depicts information that is provided by (or extracted from) HMC-captured actor ROM performance 102 (input to method 100) according to a particular embodiment. In one particular example embodiment, HMC-captured actor ROM performance 102 is captured using a pair of cameras (e.g. top and bottom) cameras. Each of these cameras generates a corresponding 2D image frame at a frame rate of multiple (e.g. 48) frames per second. These 2D image frames (or plates) 110 provide one element of HMC-captured actor ROM performance 102. Next, since there are a plurality of images 110 captured by a corresponding plurality of HMC cameras, HMC-captured actor ROM performance 102 can be used to extract a depth map 112 of the face for each frame using known stereoscopic techniques, such as those described, for example, in T. Beeler, B. Bickel, P. Beardsley and R. Summer. 2010. High-Quality Single-Shot Capture of Facial Geometry. ACM Trans. Graph. 29, 10, which is hereby incorporated herein by reference. In some embodiments, 3D reconstructions obtained by extracted using stereoscopic techniques may be further processed to obtain a depth map 112 from the perspective of one of the HMC cameras. Next, a set of optical flow data 114 is extracted between consecutive frames 110 (captured by the same camera) and between each frame and an anchor frame. Methods for computing optical flow between frames are described, for example, in T. Beeler, F. Hahn, D. Bradley, B. Bickel, P. Beardsley, C. Gotsman, R. Sumner, and M. Gross. 2011. High-Quality Passive Facial Performance Capture Using Anchor Frames. ACM Trans. Graph. 30, 4, Article 75 (July 2011), 10 pages, which is hereby incorporated herein by reference.

Optionally, one or more 2D landmarks 116 can be extracted from HMC-captured actor ROM performance 102 and used in method 100. In the illustrated example of FIG. 2, the one or more 2D landmarks 116 comprise landmarks related to the eyes and/or gaze. In some embodiments, additional or alternative 2D facial landmarks 116 (such as the lips, the nose, the cheekbones and/or the like) may be used. 2D landmarks 116 may be extracted from HMC-captured actor ROM performance 102 using any suitable technique. For example, the eye-related landmarks shown in FIG. 2 may be extracted from HMC-captured actor ROM performance 102 using techniques described in Seonwook Park, Xucong Zhang, Andreas Bulling, and Otmar Hilliges. 2018. Learning to find eye region landmarks for remote gaze estimation in unconstrained settings. In Proceedings of the 2018 ACM Symposium on Eye Tracking Research & Applications (ETRA '18). Association for Computing Machinery, New York, NY, USA, Article 21, 1-10, which is hereby incorporated herein by reference. 2D landmarks 116 may additionally or alternatively be provided as user input, for example. In both automated and user-input based techniques for extracting 2D landmarks 116, 2D landmarks 116 may specify particular vertices in the 3D mesh topology used throughout method 100 to which these 2D landmarks 116 correspond. That is, there is a correspondence between 2D landmarks 116 and 3D mesh vertices. This correspondence may be provided as user input (e.g. where 2D landmarks 116 are user-specified) or may be configured once and then re-used for different actors where the same mesh topology is used (e.g. where 2D landmarks 116 are automatically ascertained).

The other input to method 100 (FIG. 1E) is a rough actor-specific ROM 104. Rough actor-specific ROM 104 may have the same topology (e.g. number and interconnectivity of vertices) as desired output mesh (training data) 22 but is typically not very accurate. Rough actor-specific ROM 104 may comprise enough frames and a suitable range of motion to permit so-called blendshape decomposition (a form of matrix decomposition or dimensionality reduction) to be performed thereon. Such blendshape decomposition is described in more detail below. Rough actor-specific ROM 104 may be obtained in any suitable manner. In some embodiments, rough actor-specific ROM 104 may be obtained, in part, by interpolating data from other CG meshes of other actors, characters or other identities which may be provided in a suitable database of identities. In some embodiments, rough actor-specific ROM 104 may be obtained, in part, using pre-existing generic ROM animations (e.g. encoded in the form of blendshape weights) which can then be used in an animation rig for the new identity (actor). In some embodiments, rough actor-specific ROM 104 may be obtained, in part, using a generic character building tool which allows the transfer of a ROM from one identity to another one (e.g. to the actor for which method 100 is being performed). One non-limiting example of such a character building tool is described in Li, T. Bolkart, T. Black, M., Li, H. and Romero, J. (2017). Learning a model of facial shape and expression from 4D scans. ACM Transactions on Graphics. 36. 1-17., which is hereby incorporated herein by reference. Rough actor specific ROMs (like ROM 104) can be obtained in many ways, including by a family of techniques known as “morphable models”, some of which are described in Egger et al. (2020) 3D Morphable Face Models—Past, Present and Future. ACM Transactions on Graphics, Association for Computing Machinery, 39 (5), pp. 157:1-38, which is hereby incorporated herein by reference. In some embodiments, rough actor-specific ROM 104 may be obtained, in part, using other techniques such as deformation transfer, blendshape weight transfer and/or the like.

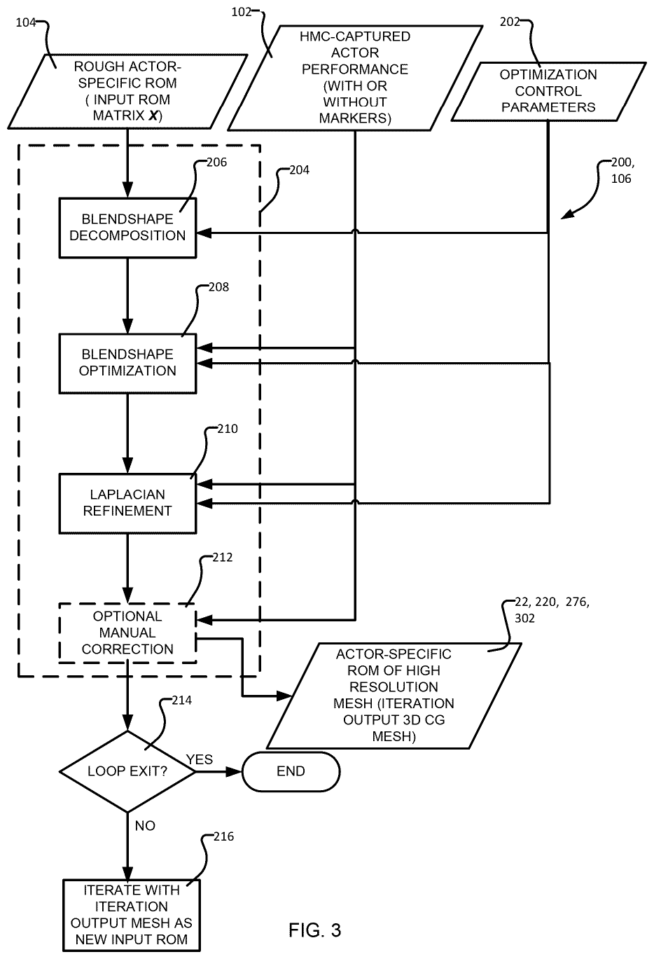

FIG. 3 shows a method 200 for generating an actor-specific ROM of a CG 3D high resolution mesh 22 (i.e. training data 22 for the FIG. 1A actor-to-mesh conversion model 14) based on an HMC-captured actor ROM performance (with or without markers) 102 and rough actor-specific ROM 104 according to a particular embodiment. Method 200 may be used to perform block 106 of method 100 (FIG. 1E) in some embodiments. Method 200 also takes as input a number of optimization control parameters 202 (some of which may be user-configurable) that are discussed in more detail in context below. As will be explained in more detail below, method 200 is framed as an iterative optimization problem, one iteration of which is shown in block 204. Each iteration of block 204 outputs an actor-specific ROM of a CG 3D high resolution mesh 220 which could possibly be used as training data 22 for the FIG. 1A actor-to-mesh conversion model 14, but would typically for the first few iterations be used as an input (in the place of rough actor-specific ROM 104) for another iteration of block 104. With a number of iterations (typically 1-3 iterations) of the block 204 optimization process, the block 204 output actor-specific ROM of a CG 3D high resolution mesh 220 is suitable for use as training data 22 for the FIG. 1A actor-to-mesh conversion model 14. The suitability of when output actor-specific ROM of a CG 3D high resolution mesh 220 is suitable for use as training data 22 may be determined by performing a number of iterations of method 200. The suitability of when output actor-specific ROM of a CG 3D high resolution mesh 220 is suitable for use as training data 22 may be determined by a user who may compare the geometry of CG 3D high resolution mesh 220 to HMC-captured actor performance 102 as well as checking for artefacts in CG 3D high resolution mesh 220. Each step of this block 204 iteration process is now explained in more detail.

Method 200 (the block 204 iteration process) starts in block 206 which involves performing a so-called blendshape decomposition on rough actor-specific ROM 104. In some embodiments, this block 206 blendshape decomposition is a principal component (PCA) decomposition. It will be understood that the block 206 blendshape decomposition (which is described herein as being a PCA decomposition) could, in general, comprise any suitable form of matrix decomposition technique or dimensionality reduction technique (e.g. independent component analysis (ICA), non-negative matrix factorization (NMF) and/or the like). For brevity, block 206, its output matrix decomposition (including its mean vector, basis matrix and weights) are described herein as being a PCA decomposition (e.g. PCA decomposition, PCA mean vector, PCA basis matrix and PCA weights). However, unless the context dictates otherwise, these elements should be understood to incorporate the process and outputs of other forms of matrix decomposition and/or dimensionality reduction techniques.

As discussed above, rough actor-specific ROM 104 is a 3D mesh of vertices over a number of frames. More specifically, rough actor-specific ROM 104 comprises a series of frames (e.g. f frames), where each frame comprises 3D (e.g. {x, y, z}) position information for a set of n vertices. Accordingly, actor-specific ROM 104 may be represented in the form of a matrix X (input ROM matrix X) of dimensionality [f, 3n]. As is known in the art of PCA matrix decomposition, block 206 PCA decomposition may output a PCA mean vector \vec{μ}, a PCA basis matrix V and a PCA weight matrix Z (not expressly shown in FIG. 3).

PCA mean vector \vec{μ} may comprise a vector of dimensionality 3n, where n is the number of vertices in rough actor-specific ROM 104 and is the desired topology of training data 22. Each element of PCA mean vector 17 may comprise the mean of a corresponding column of input ROM matrix X over the f frames. PCA basis matrix V may comprise a matrix of dimensionality [k, 3n], where k is a number of blendshapes (also referred to as eigenvectors) used in the block 206 PCA decomposition, where k≤min(f, 3n]. The parameter k may be a preconfigured and/or user-configurable parameter specified by optimization control parameters 202. The parameter k may be configurable by selecting the number k outright, by selecting a percentage of the variance in input ROM matrix X that should be explained by the k blendshapes and/or the like. In some currently preferred embodiments, the parameter k is determined by ascertaining a blendshape decomposition that has the variance to retain 99.9% of the input ROM matrix. Each of the k rows of PCA basis matrix V has 3n elements and may be referred to as a blendshape. PCA weights matrix Z may comprise a matrix of dimensionality [f, k]. Each row the matrix Z of PCA weights 23 is a set (vector) of k weights corresponding to a particular frame of input ROM matrix X.

The frames of input ROM matrix X can be approximately reconstructed from the PCA decomposition according to \hat{X}=ZV+\vec{Ψ}, where \hat{X} is a matrix of dimensionality [f, 3n] in which each row of \hat{X} represents an approximate reconstruction of one frame of input ROM matrix X and \vec{Ψ} is a matrix of dimensionality [f, 3n], where each row of \vec{Ψ} is the PCA mean vector \vec{μ}. An individual frame of input ROM matrix X can be approximately constructed according to \hat{x}=\vec{z}V+\vec{μ}, where \hat{x} is the reconstructed frame comprising a vector of dimension 3n, \vec{z} is the set (vector) of weights having dimension k selected as a row of PCA weight matrix Z (PCA weights 23). In this manner, a vector \vec{z} of weights (also referred to as blendshape weights) may be understood (together with the PCA basis matrix V and the PCA mean vector μ) to represent a frame of a 3D CG mesh.

From block 206, method 200 progresses to block 208 which involves using the block 206 PCA basis matrix V and block 206 PCA mean vector \vec{μ} and optimizing a set/vector \vec{z} of blendshape weights 222 (and a set of transform parameters 224) for each frame of HMC-captured actor performance 102 that attempts to reproduce the geometry of the corresponding frame of HMC-captured actor performance 102. The block 208 process may be referred to herein as blendshape optimization 208.

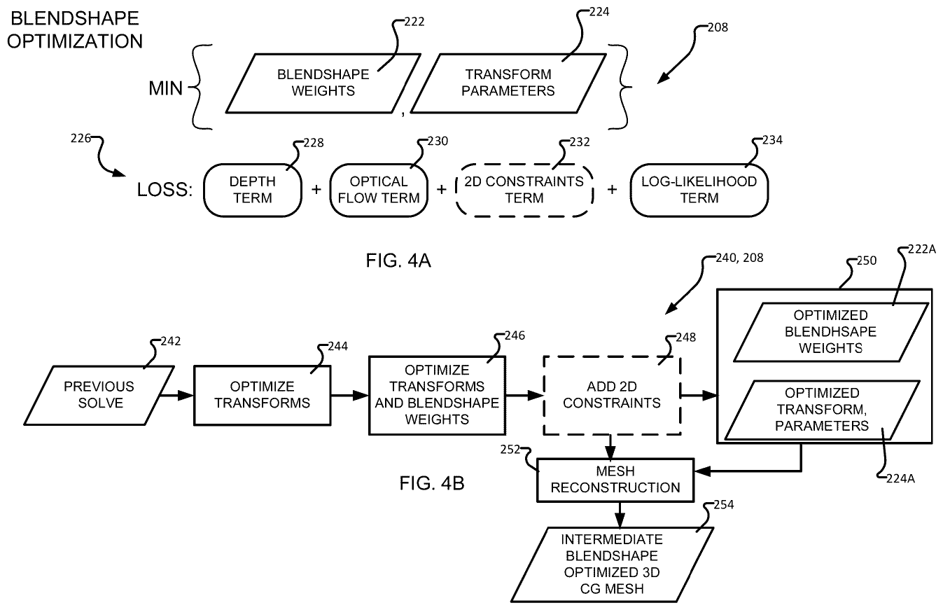

FIG. 4A schematically depicts the block 208 blendshape optimization according to a particular embodiment. Optimization 208 is performed on a frame-by-frame basis (e.g. on each frame of HMC-captured actor performance 102). For each such frame, optimization 208 involves selecting the blendshape weights 222 (e.g. a vector \vec{z} of length k) and the parameters of a model transform 224 which will minimize an objective function (also known as a loss function) 226. Blendshape weights 222 are described above. Model transform parameters 224 may comprise parameters which will transform (e.g. translate and rotate) the whole face geometry. In some embodiments, these model transform parameters comprise 3 translational parameters and 3 rotational parameters. In one particular embodiments, model transform parameters 224 comprise the 3 translational parameters and 3 rotational parameters used in an Euler-Rodrigues configuration. In the illustrated embodiment of FIG. 4A, the loss function 226 used in the blendshape optimization 208 comprises: a depth term 228, an optical flow term 230, a 2D constraints term 232 and an animation prior term 234. Each of these terms 228, 230, 232, 234 may be weighted (by a suitable weight parameter which may be pre-configured and/or user-specified as part of optimization control parameters 202) that control the relative importance of these terms on loss function 226.

Depth term 228 attributes loss to differences between values queried from the depth map 112 (see FIG. 2) of a particular frame of HMC-captured actor performance 102 and the corresponding depth computed from the 3D geometry of a mesh (predicted by reconstruction using the current blendshape weights 222 and model transform parameters 224) to the camera. The pixel coordinates used for the queries in the depth term 228 are derived by projecting the 3D vertex positions of the reconstructed mesh to image coordinates using a camera projection matrix. Some regions of depth map 112 can be relatively noisy (see, for example, the regions around the contours of the eyes and the edges of the face in the depth map 112 shown in FIG. 2). Consequently, in some embodiments, depth term 228 of loss function 226 may optionally involve using a masking process to select which vertices of the reconstructed 3D mesh geometry (reconstructed using the current blendshape weights 222 and model transform parameters 224) should be considered for the purposes of computing the depth loss term 228. Such a mask may be used, for example, to discount vertices in regions around the edges of the face, the lips and/or the eyes from consideration when computing the depth loss 228. Such a mask may be a binary mask in some embodiments—i.e. a pre-vertex mask which selects whether or not the vertex should be considered for the purposes of depth term 228. This mask may be created on a common model topology, so that it can be re-used (for the most part) for multiple different actors. Some adjustments to such masks for different actors could be user-implemented. The parameter(s) of such a mask may be preconfigured and/or user-configurable parameter(s) specified by optimization control parameters 202.

Optical flow term 230 attributes loss to differences between: the optical flow 114 of the current frame relative to a previous frame (see FIG. 2) based on of HMC-captured actor performance 102; and the displacement of the vertices (e.g. measured in image pixel coordinates) between the current frame reconstructed using the current blendshape weights 222 and model transform parameters 224 and a reconstruction of a previously solved frame. In some embodiments, some techniques may be used to identify and remove regions of noisy or otherwise undesirable optical flow from consideration in optical flow term 230. Such techniques may include, for example, round-trip error techniques and facing ratio techniques. The parameter(s) of such techniques may be preconfigured and/or user-configurable parameter(s) specified by optimization control parameters 202. Such techniques may additionally or alternatively involve the use of a mask, which may comprise the same mask used for the depth loss term 228. The parameter(s) of such a mask may be preconfigured and/or user-configurable parameter(s) specified by optimization control parameters 202.

2D constraints term 232 is an optional term that attributes loss based on differences between: where vertices associated with 2D landmarks reconstructed using the current blendshape weights 222 and model transform parameters 224 should be located (after projection to image coordinates) as compared to the locations of 2D landmarks 116 (see FIG. 2) that are identified in the current frame of HMC-captured actor performance 102. Rather than being rigid constraints to the blendshape optimization 208, these 2D constraints 232 can be incorporated into loss function 226 as soft constraints. In some embodiments, any of 2D landmark-based constraints may additionally or alternatively be formulated as rigid constraints.

In the illustrated embodiment of FIG. 4A, loss function 226 also includes a log-likelihood term 234 which attributes relatively high loss to blendshape weights 222 that are considered un-feasible. More specifically, log-likelihood term 234 may involve determining a negative log-likelihood of the locations a number p (e.g. subset p≤n) of vertices spread about the face reconstructed using the current blendshape weights 222 relative to the vertex geometry of input ROM matrix X (i.e rough actor-specific ROM 104 in the first iteration of block 204). The number p and the set of p indices may be user-configurable or pre-configured elements of optimization control parameters 202. Input ROM matrix X (i.e rough actor-specific ROM 104 in the first iteration of block 204) may be considered to be the set of feasible poses. Log-likelihood term 234 may attribute greater loss when the computed log-likelihood suggests that a reconstructed pose is further from the feasible poses of the input ROM matrix X and less loss when the computed log-likelihood suggests that a reconstructed pose is closer to the feasible poses of the input ROM matrix X. Log-likelihood term 234 may effectively bound the set of available poses (based on variations of the current blendshape weights 222) to thereby prevent the blendshape optimization 208 from unrealistic results (e.g. from potentially yielding blendshape weights 222 and model transform parameters 224 that otherwise minimize other terms of loss function 226 but yield a unfeasible face geometry).

It is possible that the block 208 blendshape optimization process could be done for all variables and the entire loss function 226 at the same time, but currently preferred embodiments of blendshape optimization 208 involve controlling this optimization to some degree. FIG. 4B depicts a controlled blendshape optimization process 240 for a particular frame according to an example embodiment. Optimization process 240 of FIG. 4B may be used in some embodiments to implement a frame of blendshape optimization 208 (FIG. 3). While not expressly shown in FIG. 4B, it will be understood that HMC-captured actor performance 102 (FIG. 3) is available as input to method 240. For each frame, method 240 is based on the optimization described above in connection with FIG. 4A and involves selecting the blendshape weights 222 (e.g. a vector \vec{z} of length k) and the parameters of a model transform 224 which will minimize an objective function (also known as a loss function) 226. Method 240 starts the optimization with the solved optimization result 242 of a previous frame (i.e. with the solved blendshape weights 222 and transform model parameters 224 of a previous frame). For the first frame, method 240 may start with blendshape weights 222 corresponding to a neutral pose and an identity matrix for transform parameters 224 (as an initial guess) and may remove optical flow term 230 from loss function 226. It will be appreciated that any frame may be selected (e.g. by a user) to be the first frame for which method 240 is performed and that the first frame need not be the temporally first frame in HMC-captured actor performance 102.

The method 240 optimization then starts in block 244 with optimizing the transform parameters 224 for the current frame—that is selecting transform parameters 224 that will minimize loss function 226 while holding blendshape weights 222 constant (at their initial values). For the purposes of the block 244 optimization of transform parameters 224, 2D constraint term 232 may be omitted from loss function 226. Then, once the optimization problem is closer to its solution, method 240 proceeds to block 246 which involves permitting blendshape weights 222 to be optimizable parameters and then optimizing the combination of blendshape weights 222 and transform parameters 224. For the purposes of the block 246 optimization of blendshape weights 222 and transform parameters 224, 2D constraint term 232 may be omitted from loss function 226. Method 240 then proceeds to block 248, which involves introducing 2D constraint term 232 (FIG. 4A) into loss function 226 and then, once again, optimizing the combination of blendshape weights 222 and transform parameters 224.

As discussed above, method 240 (blendshape optimization 208) is performed once for each frame of HMC-captured actor performance 102 (see FIG. 3). For each frame of HMC-captured actor performance 102, the output of block 248 is set 250 of optimized blendshape weights 222A and transform parameters 224A. Method 240 then proceeds to block 252 which involves reconstructing a 3D CG mesh for each frame from the optimized blendshape weights 222A. As discussed above, optimized blendshape weights 222A for a particular frame may take the form of a weight vector \vec{z} of length k which can be used (in block 252) to reconstruct a 3D vector of vertex locations according to \hat{x}=\vec{z}V+\vec{μ}, where the variables have the above-discussed definitions to thereby define intermediate blendshape-optimized 3D CG mesh 254.

For each frame of HMC-captured actor performance 102, the output of method 240 is an intermediate solution referred to herein as a blendshape-optimized 3D CG mesh 254 (reconstructed from optimized blendshape weights 222A as discussed above) and a per-frame set of optimized transform parameters 224A. It will be appreciated, that blendshape optimized 3D CG mesh 254 and the corresponding set of optimized transform parameters 224A for each of the frames of HMC-captured actor performance 102 are also the outputs of the block 208 blendshape optimization (FIG. 3), but these outputs are not expressly shown in FIG. 3 to avoid cluttering. Blendshape optimized 3D mesh 254 may be represented by a matrix B having dimensionality [g, 3n], where g is the number of frames of HMC-captured actor performance 102, n is the number of vertices in the mesh and 3n represents 3 coordinates (e.g. {x, y, z} coordinates) for each of the n vertices. The matrix B may be referred to herein as the blendshape optimized 3D CG mesh matrix B. It should be noted here that blendshape-optimized 3D CG mesh 254 will not (on its own) match HMC-captured actor performance 102, because blendshape-optimized 3D CG mesh 254 is not transformed. Only when the transformation prescribed by the corresponding optimized transform parameters 224A is applied to the frames of blendshape-optimized 3D CG mesh 254 will the resulting mesh approximate HMC-captured actor performance 102. In this sense, blendshape-optimized 3D CG mesh 254 may be understood to be in a canonical (un-transformed) state which represents facial expression but not head position or head orientation.

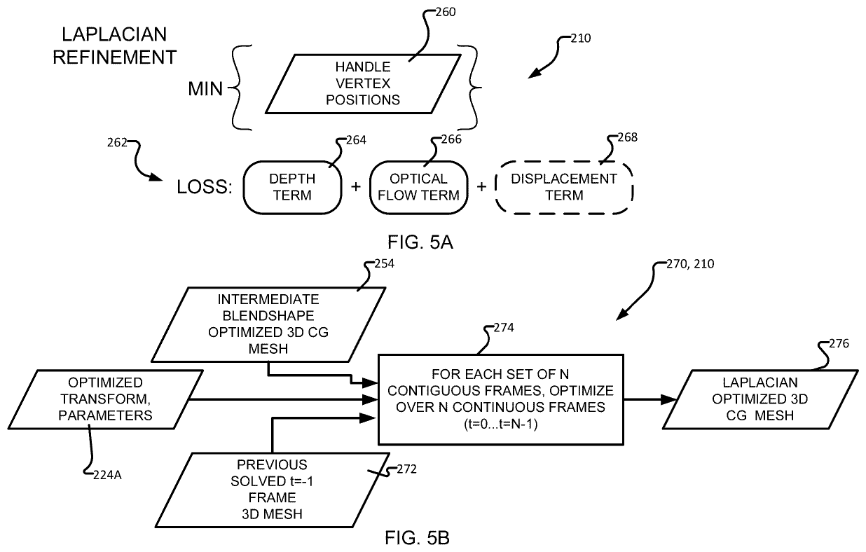

Returning to FIG. 3, method 200 then proceeds from the block 208 blendshape optimization to block 210 which involves taking, as input, blendshape optimized 3D CG mesh 254 (blendshape optimized 3D CG mesh matrix B) and optimized transform parameters 224A, and further refining the result. The block 210 process may be referred to herein as Laplacian refinement 210. FIG. 5A schematically depicts the block 210 Laplacian refinement according to a particular embodiment. Laplacian refinement 210 is another optimization process which attempts to further optimize blendshape optimized 3D CG mesh 254 (blendshape optimized 3D CG mesh matrix B) to more closely match HMC-captured actor performance 102. Instead of optimizing over blendshape weights or transform parameters, Laplacian refinement 210 comprises optimizing over the geometric locations of a number m (m≤n) of “handle” vertices 260. The indices of handle vertices 260 may be provided as part of optimization control parameters 202 (FIG. 3). In some embodiments, handle vertices 260 may be user-selected (e.g. by an artist), although this is not necessary and handle vertices 260 may be pre-configured or otherwise automatically selected. In some embodiments, handle vertices 260 may be selected so as to be relatively more concentrated in regions of the face that are relatively more expressive (e.g. on the lips, in the regions under the eyes or the like) and relatively less concentrated in regions of the face that are relatively less expressive (e.g. the sides of the cheeks and the top of the forehead).

While the handle vertices 260 are the only vertices optimized in Laplacian refinement 210, the loss (objective) function 262 used in Laplacian refinement 210 may be computed over all n vertices of the mesh. For this loss computation, the positions of non-handle vertices may be deformed by Laplacian deformation based on the variation in the positions of handle vertices 260 in accordance with the technique described in O. Sorkine. 2005. Laplacian Mesh Processing. In Eurographics 2005—State of the Art Reports. The Eurographics Association [Sorkine], which is hereby incorporated herein by reference. The geometry of each frame output as a blendshape-optimized 3D CG mesh 254 from the blendshape optimization 240, 208 may be used as the base mesh (base vertex positions) to generate the Laplacian operator defined in the Sorkine technique. In some embodiments, in addition to or in the alternative to Laplacian deformation, the positions of non-handle vertices may be deformed by bi-Laplacian deformation based on the variation in the positions of handle vertices 260. In some embodiments, the positions of non-handle vertices may be deformed by a linear combination of Laplacian and bi-Laplacian deformation based on the variation in the positions of handle vertices 260, where the weights for each of the Laplacian and bi-Laplacian portions of the deformation may be user-configurable or pre-configured parameters of optimization control parameters 202 (FIG. 3). In this way, while only handle vertices 260 are optimized, Laplacian refinement 210 attempts to ensure that the surface of the mesh more broadly approaches a match with HMC-captured actor performance 102 for each frame of HMC-captured actor performance 102 (and that this matching is not limited to just the varying handle vertices 260). In some embodiments, other mesh manipulation/deformation techniques could be used in addition to or in the alternative to Laplacian and/or bi-Laplacian techniques. Such techniques may include, by way of non-limiting example, the “as-rigid-as-possible” technique described in Sorkine, O. and Alexa, M. (2007). As-Rigid-As-Possible Surface Modeling. Symposium on Geometry Processing. 109-116 and/or the “pyramid coordinates” technique described in A. Sheffer and V. Kraevoy, “Pyramid coordinates for morphing and deformation,” Proceedings. 2nd International Symposium on 3D Data Processing, Visualization and Transmission, 2004. 3DPVT 2004., 2004, pp. 68-75., both of which are hereby incorporated herein by reference.

In the illustrated embodiment of FIG. 5A, the loss function 262 used in the Laplacian refinement comprises: a depth term 264, an optical flow term 266, an optional displacement term 268. While the optimization is over handle vertices 260, the depth term 264 and optical flow term 266 of loss function 262 used in Laplacian refinement 210 may be substantially the same as depth term 228 and optical flow term 230 (FIG. 4A) of loss function 226 used in the blendshape optimization process 208. Evaluating depth term 228 and optical flow term of loss function 262 may involve transforming the positions of the vertices (handle vertices 260 and Laplacian-deformed non-handle vertices) using optimized transform parameters 224A determined in the blendshape optimization of block 208 for the purposes of comparing to HMC-captured actor performance 102. Optional displacement term 268 comprises a per-vertex weight, which expresses a relative confidence in the positions of each vertex output from the block 208 blendshape optimization process or, conversely, a lack of confidence in the depth loss term 264 and optical flow loss term of loss function 262 used in the block 210 Laplacian refinement process. The per-vertex weights of displacement term 268 may be thought of intuitively as a mask, but unlike the masks used for depth terms 228, 264 and optical flow terms 230, 266 the mask of displacement term 268 is non-binary and may have weights that are represented, for example, as a scalar in a range [0,1]. For regions of the face where there is higher degree of confidence in the block 208 blendshape optimization process, displacement term 268 may attribute relatively high cost/loss for deforming vertex positions in these regions as part of Laplacian refinement 210. Conversely, for regions of the face where there is a lower degree of confidence in the block 208 blendshape optimization process, displacement term 268 may attribute relatively low (or even zero) cost/loss for deforming vertex positions in these regions as part of Laplacian refinement 210. The non-binary (per-vertex) weight masks used in displacement term 268 may be, for the most part, re-used for different actors, where HMC-captured actor performance 102 is captured from similarly placed cameras (e.g. using the same HMC set-up) and where the base topology (i.e. the n vertices of the 3D CG mesh) is the same.

As discussed above, the block 210 Laplacian refinement process optimizes over handle vertices 260, but for computation of loss function 262 deformation of the positions of non-handle vertices is handled using Laplacian deformation and/or bi-Laplacian deformation which involves computation of a matrix L (referred to herein as a Laplacian matrix L, without loss of generality as to whether the matrix is strictly a Laplacian matrix, a bi-Laplacian matrix or a combination of Laplacian and bi-Laplacian). Matrix L is a matrix of dimensionality [3n, 3n] where n is the number of vertices in the mesh topology, as described above. Then, for each frame, deformation of the vertices may be computed using the Laplacian deformation framework as described, for example, in Sorkine. 2005. Laplacian Mesh Processing. In Eurographics 2005—State of the Art Reports. The Eurographics Association [Sorkine], based on the matrix L, the varying positions of handle vertices 260 and the blendshape-optimized vertex positions 254. The displacement loss term 268 may use a single Laplacian matrix L derived from a neutral mesh or other pose extracted or selected from rough actor-specific ROM 104. Displacement loss term 268 may be computed by (i) converting the deformed vertex positions to vertex displacements, by subtracting their positions relative to the positions from the geometry of each frame output as blendshape-optimized 3D-CG mesh 254 from the blendshape optimization 240, 208 to provide a displacement vector \vec{d} with length 3n; (ii) scaling the vertex displacements \vec{d} by a function (e.g. a square-root) of the per-vertex weights of displacement term 268 described above to yield a weighted displacement vector \vec{e}; and (iii) computing displacement loss term 268 (displacement loss term L_{d}) according to L_{d}=\vec{e}^{T}L\vec{e}. Additionally or alternatively, displacement loss term 268 may be computed by (i) converting the deformed vertex positions to vertex displacements (subtracting the positions from the neutral mesh position extracted from rough actor-specific ROM 104), to provide a displacement vector \vec{d} with length 3n; (ii) scaling the vertex displacements \vec{d} by a function (e.g. a square-root) of the per-vertex weights of displacement term 268 described above to yield a weighted displacement vector \vec{e}; and (iii) computing displacement loss term 268 (displacement loss term L_{d}) according to L_{d}=\vec{e}^{T}L\vec{e}.

Like the block 208 blendshape optimization, the inventors have determined that superior results are obtained from Laplacian refinement 210 when the optimization of the block 210 Laplacian refinement is controlled to some degree. FIG. 5B depicts a controlled Laplacian refinement method 270 according to an example embodiment. Method 270 may be used to implement Laplacian refinement 210 (FIG. 3) in some embodiments. While not expressly shown in FIG. 5B, it will be understood that HMC-captured actor performance 102 (FIG. 3) is available as input to method 270. As discussed above, method 270 involves, for each frame of HMC-captured actor performance 102, selecting handle vertices 260 that will minimize an objective function (also known as loss function) 262. However, rather than solve for each frame individually, method 270 (in block 274) involves solving for groups of N contiguous frames of HMC-captured actor performance 102 in batches and, correspondingly, using a loss function which is some function of the loss functions 262 for each of the N contiguous frames (e.g. the sum of the loss functions 262 for each of the N contiguous frames). The parameter N may be a preconfigured and/or user-configurable parameter specified by optimization control parameters 202. Solving contiguous frames in block 274 may allow contiguous frames to influence each other (e.g. via the optical flow that is used to match vertex positions within consecutive frames. Further, the inventors have ascertained that optimizing groups of contiguous frames produces more temporally consistent results (i.e. solutions that are more stable within the batch of contiguous frames) by reducing noise associated with depth term 264 and optical flow term 266.

Further, method 270 may comprise, for each batch of N contiguous frames, starting with the mesh geometry of an immediately preceding frame 272 that has already been solved and that is not part of the block 274 optimization, but instead is fixed and serves as an anchor to the block 274 optimization process to mitigate discontinuities and/or other spurious results between batches of contiguous frames. This immediately preceding frame 272 is shown in FIG. 5B as the t=−1 frame 272, whereas the frames being optimized in block 274 are the t=0 to t=N−1 frames. In particular, the mesh geometry of the previously solved (t=−1) frame 272 may be used to compute optical flow loss term 266 corresponding to the next (t=0) frame. The first frame solved using method 270 (which may preferably be close to a neutral pose) may be solved individually using the same technique described above for method 240 (by removing optical flow term 266 and, optionally, displacement term 268) from loss function 262. Once this first frame is determined, then it may be the t=−1 frame 272 for the next batch of N contiguous frames. The initial guesses for the locations of the handle vertices 260 in the method 270 optimization may comprise the 3D locations associated with blendshape-optimized 3D CG mesh 254 from blendshape optimization 208.

For each frame of HMC-captured actor performance 102, the output of method 270 is a solution referred to herein as a Laplacian-optimized 3D CG mesh 276. It will be appreciated, that Laplacian-optimized 3D CG mesh 276 for each of the frames of HMC-captured actor performance 102 is also an output of the block 2210 Laplacian refinement (FIG. 3), but Laplacian-optimized 3D CG mesh 276 is not expressly shown in FIG. 3 to avoid cluttering. Laplacian-optimized 3D mesh 276 may be represented by a matrix C having dimensionality [g, 3n], where g is the number of frames of HMC-captured actor performance 102, n is the number of vertices in the mesh and 3n represents 3 coordinates (e.g. {x, y, z} coordinates) for each of the n vertices. The matrix C may be referred to herein as the Laplacian-optimized 3D CG mesh matrix C. It should be noted here that Laplacian-optimized 3D CG mesh 276 will not (on its own) match HMC-captured actor performance 102, because Laplacian-optimized 3D CG mesh 276 is not transformed. Only when the transformation prescribed by the corresponding per-frame optimized transform parameters 224A (see FIG. 4B) is applied to the frames of Laplacian-optimized 3D CG mesh 276 will the resulting mesh approximate HMC-captured actor performance 102. In this sense, Laplacian-optimized 3D CG mesh 276 may be understood to be in a canonical (un-transformed) state which represents facial expression but not head position or head orientation.

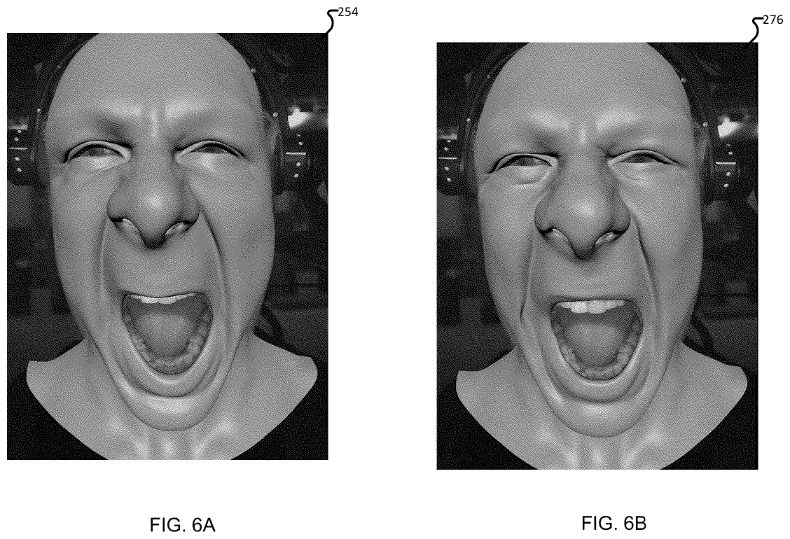

The inventors have observed that Laplacian-optimized 3D CG mesh 276 (once transformed using optimized transform parameters 224A) has improved fidelity to HMC-captured actor performance 102 than does blendshape-optimized 3D CG mesh 254 (once transformed using optimized transform parameters 224A). This can be seen, for example in FIGS. 6A and 6B which respectively depict renderings of a frame of blendshape-optimized 3D CG mesh 254 once transformed using optimized transform parameters 224A (FIG. 6A) and a corresponding frame of Laplacian-optimized 3D CG mesh 276 once transformed using optimized transform parameters 224A (FIG. 6B). Improved detail can be seen, for example, around the eyes, smile lines and lips of Laplacian-optimized 3D CG mesh 276, relative to blendshape-optimized 3D CG mesh 254.

Returning to FIG. 3, method 200 then proceeds from the block 210 Laplacian optimization to optional block 212 which involves manual user correction of Laplacian-optimized 3D CG mesh 276 (Laplacian-optimized 3D CG mesh matrix C) output from block 210. Block 212 may use optimized transform parameters 224A to transform Laplacian-optimized 3D CG mesh 276 to thereby permit direct user comparison to HMC-captured actor performance 102. Optional manual correction in block 212 may also involve looking for artefacts in Laplacian-optimized 3D CG mesh 276 (transformed or otherwise).

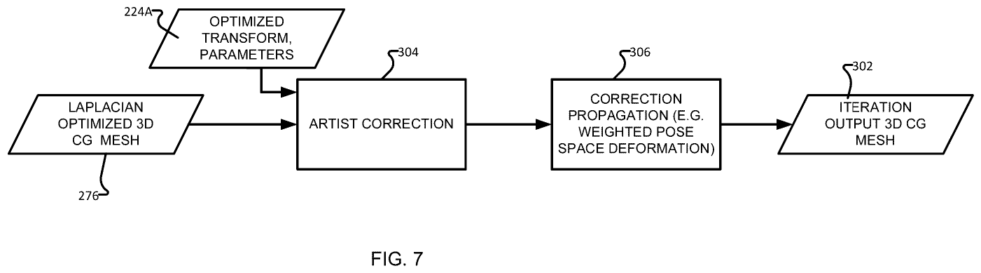

FIG. 7 depicts a method 300 for incorporating manual fixes to Laplacian-optimized 3D CG mesh 276 to obtain an iteration output 3D CG mesh 302 according to a particular embodiment. Method 300 may be used to perform the block 212 manual correction procedure in some embodiments. Method 300 may receive as input Laplacian-optimized 3D CG mesh 276 (output from Laplacian refinement block 210) and optimized transform parameters 224A (output from blendshape optimization block 208). While not expressly shown in FIG. 7, it will be understood that HMC-captured actor performance 102 (FIG. 3) may also be available as input to method 300. Method 300 begins in block 304 which involves allowing an artist to correct or otherwise manipulate individual frames. This block 304 manipulation can be accommodated in any suitable way (e.g. using a suitable user interface or the like). As discussed above, block 304 may involve using optimized transform parameters 224A to transform Laplacian-optimized 3D CG mesh 276 to thereby permit direct user comparison to HMC-captured actor performance 102 and/or block 304 may involve user-correction of artefacts in Laplacian-optimized 3D CG mesh 276. The block 304 manual correction process need not be perfect, and instead may focus on relatively large errors, because (as will be explained in more detail below) block 204 (FIG. 3) may be iterated to perform further optimization.

Method 300 then proceeds to block 306 which involves propagating the block 304 individual frame corrections to other frames (e.g. to other untransformed frames of Laplacian optimized 3D mesh 276. One suitable and non-limiting technique for propagating individual frame corrections to other frames in block 306 is the so-called weighted pose-space deformation (WPSD) technique disclosed in B. Bickel, M. Lang, M. Botsch, M. A. Otaduy, and M. Gross. 2008. Pose-space Animation and Transfer of Facial Details. In Proceedings of the 2008 ACM SIGGRAPH/Eurographics Symposium on Computer Animation (SCA '08). Eurographics Association, Aire-la-Ville, Switzerland, Switzerland, 57-66, which is hereby incorporated herein by reference.

The output of the block 306 correction propagation process is an iteration output 3D CG mesh 302. Iteration output 3D CG mesh 302 represents the output of one iteration of block 204 (FIG. 3). Iteration output 3D CG mesh 302 may be represented by a matrix D having dimensionality [g, 3n], where g is the number of frames of HMC-captured actor performance 102, n is the number of vertices in the mesh and 3n represents 3 coordinates (e.g. {x, y, z} coordinates) for each of the n vertices. The matrix D may be referred to herein as the iteration output 3D CG mesh matrix D. It should be noted here that iteration output 3D CG mesh 302 will not (on its own) match HMC-captured actor performance 102, because iteration output 3D CG mesh 302 is not transformed. Only when the transformation prescribed by the corresponding per-frame optimized transform parameters 224A (see FIG. 4B) is applied to the frames of iteration output 3D CG mesh 302 will the resulting mesh line up with the footage of the respective camera of HMC-captured actor performance 102. In this sense, iteration output 3D CG mesh 302 may be understood to be in a canonical (un-transformed) state which represents facial expression but not head position or head orientation.

Returning to FIG. 3, as discussed above, the block 212 manual correction process is optional. In cases where the block 212 manual correction process is not performed, then Laplacian-optimized 3D CG mesh 276 output from the block 210 Laplacian refinement process may be iteration output 3D mesh 302 output from the block 204 iteration. In some embodiments, one or more block 204 iterations are performed without using optional block 212 manual correction process and then the block 212 manual correction process 212 is used in the last iteration of block 204.

At block 214 (FIG. 3), iteration output 3D mesh 302 output from the current block 204 iteration is evaluated to determine if iteration output 3D mesh 302 is suitable for use as training data 22 for use in the block 20 training process shown in method 10 of FIG. 1A. In current embodiments, this block 214 evaluation is performed by a user/artist. If the artist determines that iteration output 3D mesh 302 is acceptable, then iteration output mesh 302 becomes training data 22 and method 200 ends. If the artist determines that iteration output 3D mesh 302 is not acceptable, then method 200 proceeds to block 216. In the illustrated embodiment, block 216 indicates that another iteration of the block 204 process is performed, except that in the new iteration of block 204, iteration output 3D mesh 302 may be used as input in the place of rough actor-specific ROM 104. In some embodiments, the artist may choose to adjust some of the optimization control parameters 202 for the next block 204 iteration.

The discussion presented above describes methods (e.g. method 100, block 106, method 200) for generating training data 22 in the form of an actor-specific ROM of a high resolution mesh that can be used to train an actor-to-mesh conversion model 14 (see block 20 of FIG. 1A). The actor-to-mesh conversion model 14 can then be used to convert any HMC-captured actor performance 12 to a 3D CG mesh of the actor performance 18, as described above in connection with FIG. 1A. In some embodiments, however, the methods described herein (e.g. method 100, block 106, method 200) may be used to perform the function of actor-to-mesh conversion model 14 (i.e. the functionality of block 16 in method 10 of FIG. 1A) by using a general HMC-captured actor performance (shown as HMC-captured actor performance 12 in FIG. 1A) in place of HMC-captured actor-specific ROM performance 102 for method 100, block 106 and/or method 200. That is, method 100, block 106 and/or method 200 may be used to convert a general HMC-captured actor performance 12 to a corresponding 3D CG mesh of the actor performance 18 by using the general HMC-captured actor performance 12 in the place of HMC-captured actor-specific ROM performance 102.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.
Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Software and other modules may reside on servers, workstations, personal computers, tablet computers, image data encoders, image data decoders, PDAs, color-grading tools, video projectors, audio-visual receivers, displays (such as televisions), digital cinema projectors, media players, and other devices suitable for the purposes described herein. Those skilled in the relevant art will appreciate that aspects of the system can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics (e.g., video projectors, audio-visual receivers, displays, such as televisions, and the like), set-top boxes, color-grading tools, network PCs, mini-computers, mainframe computers, and the like.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method for generating training data in a form of a plurality of frames of facial animation, each of the plurality of frames represented as a three-dimensional (3D) mesh comprising a plurality of vertices, the training data usable to train an actor-specific actor-to-mesh conversion model which, when trained, receives a performance of the actor captured by a head-mounted camera (HMC) set-up and infers a corresponding actor-specific 3D mesh of the performance of the actor, the method comprising:
receiving, as input, an actor range of motion (ROM) performance captured by a HMC set-up, the HMC-captured ROM performance comprising a number of frames of high resolution image data, each frame captured by a plurality of cameras to provide a corresponding plurality of images for each frame;
receiving or generating an approximate actor-specific ROM of a 3D mesh topology comprising a plurality of vertices, the approximate actor-specific ROM comprising a number of frames of the 3D mesh topology, each frame specifying the 3D positions of the plurality of vertices;
performing a blendshape decomposition of the approximate actor-specific ROM to yield a blendshape basis or a plurality of blendshapes;
performing a blendshape optimization to obtain a blendshape-optimized 3D mesh, the blendshape optimization comprising determining, for each frame of the HMC-captured ROM performance, a vector of blendshape weights and a plurality of transformation parameters which, when applied to the blendshape basis to reconstruct the 3D mesh topology, minimize a blendshape optimization loss function which attributes loss to differences between the reconstructed 3D mesh topology and the frame of the HMC-captured ROM performance;
performing a mesh-deformation refinement on the blendshape-optimized 3D mesh to obtain a mesh-deformation-optimized 3D mesh, the mesh-deformation refinement comprising determining, for each frame of the HMC-captured ROM performance, 3D locations of a plurality of handle vertices which, when applied to the blendshape-optimized 3D mesh using a mesh-deformation technique, minimize a mesh-deformation refinement loss function which attributes loss to differences between the deformed 3D mesh topology and the HMC-captured ROM performance;
generating the training data based on the mesh-deformation-optimized 3D mesh.

2. The method according to claim 1 wherein the blendshape optimization loss function comprises a likelihood term that attributes: relatively high loss to vectors of blendshape weights which, when applied to the blendshape basis to reconstruct the 3D mesh topology, result in reconstructed 3D meshes that are relatively less feasible based on the approximate actor-specific ROM; and relatively low loss to vectors of blendshape weights which, when applied to the blendshape basis to reconstruct the 3D mesh topology, result in reconstructed 3D meshes that are relatively more feasible based on the approximate actor-specific ROM.

3. The method of claim 2 wherein, for each vector of blendshape weights, the likelihood term is based on a negative log-likelihood of locations of a subset of vertices reconstructed using the vector of blendshape weights relative to locations of vertices of the approximate actor-specific ROM.

4. The method of claim 1 wherein the blendshape optimization comprises, for each of a plurality of frames of the HMC-captured ROM performance, starting the blendshape optimization process using a vector of blendshape weights and a plurality of transformation parameters previously optimized for a preceding frame of the HMC-captured ROM performance.

5. The method of claim 1 wherein performing the mesh-deformation refinement comprises determining, for each frame of the HMC-captured ROM performance, 3D locations of the plurality of handle vertices which, when applied to the blendshape-optimized 3D mesh using the mesh-deformation technique for successive pluralities of N frames of the HMC-captured ROM performance, minimize the mesh-deformation refinement loss function.

6. The method of claim 5 wherein the mesh-deformation refinement loss function attributes loss to differences between the deformed 3D mesh topology and the HMC-captured ROM performance over each successive plurality of N frames.

7. The method of claim 5 wherein determining, for each frame of the HMC-captured ROM performance, 3D locations of the plurality of handle vertices comprises, for each successive plurality of N frames of the HMC-captured ROM performance, using an estimate of 3D locations of the plurality of handle vertices from a frame of the of the HMC-captured ROM performance that precedes the current plurality of N frames of the HMC-captured ROM performance to determine at least part of the mesh-deformation refinement loss function.

8. The method of claim 1 wherein performing the mesh-deformation refinement comprises, for each frame of the HMC-captured ROM performance, starting with 3D locations of the plurality of handle vertices from the blendshape-optimized 3D mesh.

9. The method of claim 1 wherein the mesh deformation technique comprises at least one of: a Laplacian mesh deformation, a bi-Laplacian mesh deformation, and a combination of the Laplacian mesh deformation and the bi-Laplacian mesh deformation.

10. The method of claim 9 wherein the mesh deformation technique comprises a linear combination of the Laplacian mesh deformation and the bi-Laplacian mesh deformation.

11. The method of claim 10 wherein weights for the linear combination of the Laplacian mesh deformation and the bi-Laplacian mesh deformation are user-configurable parameters.

12. The method of claim 1 wherein generating the training data based on the mesh-deformation-optimized 3D mesh comprises performing at least one additional iteration of the steps of:
performing the blendshape decomposition;
performing the blendshape optimization;
performing the mesh-deformation refinement; and
generating the training data;
using the mesh-deformation-optimized 3D mesh from the preceding iteration of these steps as an input in place of the approximate actor-specific ROM.

13. The method of claim 1 wherein generating the training data based on the mesh-deformation-optimized 3D mesh comprises:
receiving user input;
modifying one or more frames of the mesh-deformation-optimized 3D mesh based on the user input to thereby provide an iteration output 3D mesh;
generating the training data based on the iteration output 3D mesh.

14. The method of claim 13 wherein the user input is indicative of a modification to one or more initial frames of the mesh-deformation-optimized 3D mesh and wherein modifying the one or more frames of the mesh-deformation-optimized 3D mesh based on the user input comprises:
propagating the modification from the one or more initial frames to one or more further frames of the mesh-deformation-optimized 3D mesh to provide the iteration output 3D mesh.

15. The method of claim 14 wherein propagating the modification from the one or more initial frames to the one or more further frames comprises implementing a weighted pose-space deformation (WPSD) process.

16. The method of claim 13 wherein generating the training data based on the iteration output 3D mesh comprises performing at least one additional iteration of the steps of:
performing the blendshape decomposition;
performing the blendshape optimization;
performing the mesh-deformation refinement; and
generating the training data;
using the iteration output 3D mesh from the preceding iteration of these steps as an input in place of the approximate actor-specific ROM.

17. The method of claim 1 wherein the blendshape optimization loss function comprises a depth term that, for each frame of the HMC-captured ROM performance, attributes loss to differences between depths determined on a basis of the reconstructed 3D mesh topology and depths determined on a basis of the HMC-captured ROM performance.

18. The method of claim 1 wherein the blendshape optimization loss function comprises an optical flow term that, for each frame of the HMC-captured ROM performance, attributes loss to differences between: optical loss determined on a basis of HMC-captured ROM performance for the current frame and at least one preceding frame; and displacement of the vertices of the reconstructed 3D mesh topology between the current frame and the at least one preceding frame.

19. The method of claim 17 wherein determining, for each frame of the HMC-captured ROM performance, the vector of blendshape weights and the plurality of transformation parameters which, when applied to the blendshape basis to reconstruct the 3D mesh topology, minimize the blendshape optimization loss function comprises:
starting by holding the vector of blendshape weights constant and optimizing the plurality of transformation parameters to minimize the blendshape optimization loss function to determine an interim plurality of transformation parameters; and
after determining the interim plurality of transformation parameters, allowing the vector of blendshape weights to vary and optimizing the vector of blendshape weights and the plurality of transformation parameters to minimize the blendshape optimization loss function to determine the optimized vector of blendshape weights and plurality of transformation parameters.

20. The method of claim 17 wherein determining, for each frame of the HMC-captured ROM performance, the vector of blendshape weights and the plurality of transformation parameters which, when applied to the blendshape basis to reconstruct the 3D mesh topology, minimize the blendshape optimization loss function comprises:
starting by holding the vector of blendshape weights constant and optimizing the plurality of transformation parameters to minimize the blendshape optimization loss function to determine an interim plurality of transformation parameters; and
after determining the interim plurality of transformation parameters, allowing the vector of blendshape weights to vary and optimizing the vector of blendshape weights and the plurality of transformation parameters to minimize the blendshape optimization loss function to determine an interim vector of blendshape weights and a further interim plurality of transformation parameters;
after determining the interim vector of blendshape weights and further interim plurality of transformation parameters, introducing a 2-dimensional (2D) constraint term to the blendshape optimization loss function to obtain a modified blendshape optimization loss function and optimizing the vector of blendshape weights and the plurality of transformation parameters to minimize the modified blendshape optimization loss function to determine the optimized vector of blendshape weights and plurality of transformation parameters.

21. The method of claim 20 wherein the 2D constraint term attributes loss, for each frame of the HMC-captured ROM performance, based on differences between locations of vertices associated with 2D landmarks in the reconstructed 3D mesh topology and locations of 2D landmarks identified in the current frame of the HMC-captured ROM performance.

22. The method of claim 1 wherein the mesh-deformation refinement loss function comprises a depth term that, for each frame of the HMC-captured ROM performance, attributes loss to differences between depths determined on a basis of the 3D locations of the plurality of handle vertices applied to the blendshape-optimized 3D mesh using the mesh-deformation technique and depths determined on a basis of the HMC-captured ROM performance.

23. The method of claim 1 the mesh-deformation refinement loss function comprises an optical flow term that, for each frame of the HMC-captured ROM performance, attributes loss to differences between: optical loss determined on a basis of HMC-captured ROM performance for the current frame and at least one preceding frame; and displacement of the vertices determined on a basis of the 3D locations of the plurality of handle vertices applied to the blendshape-optimized 3D mesh using the mesh-deformation technique for the current frame and the at least one preceding frame.

24. The method of claim 1 wherein the mesh-deformation refinement loss function comprises a displacement term which, for each frame of the HMC-captured ROM performance, comprises a per-vertex parameter which expresses a degree of confidence in the vertex positions of the blendshape-optimized 3D mesh.

25. A method for generating a plurality of frames of facial animation corresponding to a performance of an actor captured by a head-mounted camera (HMC) set-up, each of the plurality of frames of facial animation represented as a three-dimensional (3D) mesh comprising a plurality of vertices, the method comprising:
receiving, as input, an actor performance captured by a HMC set-up, the HMC-captured actor performance comprising a number of frames of high resolution image data, each frame captured by a plurality of cameras to provide a corresponding plurality of images for each frame;
receiving or generating an approximate actor-specific ROM of a 3D mesh topology comprising a plurality of vertices, the approximate actor-specific ROM comprising a number of frames of the 3D mesh topology, each frame specifying the 3D positions of the plurality of vertices;
performing a blendshape decomposition of the approximate actor-specific ROM to yield a blendshape basis or a plurality of blendshapes;
performing a blendshape optimization to obtain a blendshape-optimized 3D mesh, the blendshape optimization comprising determining, for each frame of the HMC-captured actor performance, a vector of blendshape weights and a plurality of transformation parameters which, when applied to the blendshape basis to reconstruct the 3D mesh topology, minimize a blendshape optimization loss function which attributes loss to differences between the reconstructed 3D mesh topology and the frame of the HMC-captured actor performance;
performing a mesh-deformation refinement on the blendshape-optimized 3D mesh to obtain a mesh-deformation-optimized 3D mesh, the mesh-deformation refinement comprising determining, for each frame of the HMC-captured actor performance, 3D locations of a plurality of handle vertices which, when applied to the blendshape-optimized 3D mesh using a mesh-deformation technique, minimize a mesh-deformation refinement loss function which attributes loss to differences between the deformed 3D mesh topology and the HMC-captured actor performance;
generating the plurality of frames of facial animation based on the mesh-deformation-optimized 3D mesh.

26. The method of claim 25 wherein HMC-captured actor performance is substituted for HMC-captured ROM performance and wherein plurality of frames of facial animation is substituted for training data.

27. An apparatus comprising a processor configured (e.g. by suitable programming) to perform the method of claim 1.

28. A computer program product comprising a non-transitory medium which carries a set of computer-readable instructions which, when executed by a data processor, cause the data processor to execute the method of claim 1.
